(19) United States
(12) Patent Application Publication
(10) Pub. No.: US 2010/0198947 A1
(43) Pub. Date: Aug. 5, 2010

(54) System and Method for Dynamically Processing Electronic Data Between Multiple Data Sources

(75) Inventors: Joey Lee Daughtery, Greenville, TX (US); John N. Carbone, Garland, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/365,361

(22) Filed: Feb. 4, 2009

(51) Int. Cl. G06F 15/177; G06F 9/44

(52) U.S. Cl. 709/221; 717/171

(57) ABSTRACT

According to an embodiment of the disclosure, a method for dynamically processing electronic data between multiple data sources comprises obtaining a first data set from a data source. A run-time updateable configuration file is consulted to determine a first destination for the first data set. The first data set is transmitted to the first destination and the run-time updateable configuration file is again consulted at the first destination to determine instructions for processing of the first data set, the instructions for processing the first data set comprising conversion information and the first destination being a data translator. The data translator converts the first data set according to the conversion information to yield a processed first data set. The run-time updateable configuration file is again consulted to determine a second destination for the processed first data set, whereupon the processed first data set is transmitted to the second destination. A remote administrator computer may update the run-time updateable configuration file.

### TECHNICAL FIELD OF THE INVENTION

This invention relates to data processing systems and, more specifically, to a system and method for dynamically processing electronic data between multiple data sources.

### BACKGROUND OF THE INVENTION

A variety of different types of data exists in databases. Often, the formats of data in one database are disparate from the formats of data in other databases.

### SUMMARY OF THE INVENTION

According to an embodiment of the disclosure, a method for dynamically processing electronic data between multiple data sources comprises obtaining a first data set from a data source. A run-time updateable configuration file is consulted to determine a first destination for the first data set. The first data set is transmitted to the first destination and the run-time updateable configuration file is again consulted at the first destination to determine instructions for processing of the first data set, the instructions for processing the first data set comprising conversion information and the first destination being a data translator. The data translator converts the first data set according to the conversion information to yield a processed first data set. The run-time updateable configuration file is again consulted to determine a second destination for the processed first data set, whereupon the processed first data set is transmitted to the second destination. A remote administrator computer may update the run-time updateable configuration file.

Certain embodiments of the invention may provide numerous technical advantages. For example, a technical advantage of one embodiment may include the capability to provide an updateable run-time configuration file to handle the conversion and/or manipulation of data between one database and another database. Other technical advantages of other embodiments may include the capability to update multiple operations of data transfer system with a remotely administered configuration file.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

To provide a more complete understanding of embodiments of the present invention and features and advantages thereof, reference is made to the following description, taken in conjunction with the accompanying figures, wherein like reference numerals represent like parts, in which:

FIG. 1 illustrates a data processing system for dynamically processing data between multiple data sources according to various embodiments of the invention;

FIG. 2 is a flowchart illustrating a series of example steps associated with dynamically discovering and translating data as a single autonomous operation performed by logic encoded in a computer readable media; and

FIG. 3 is a chart illustrating how information might flow through an embodiment of system designed to process known database data.

### DETAILED DESCRIPTION OF EXAMPLE EMBODIMENTS OF THE INVENTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

Conventionally, when one type of data structure needs to be converted to another type of data structure, special programs needs to be created to carry out the conversion. Difficulties can arise when a variety of disparate data structures exist. Accordingly, teaching of certain embodiments recognize an updateable configuration file, which can be used to handle conversion of many types of data.

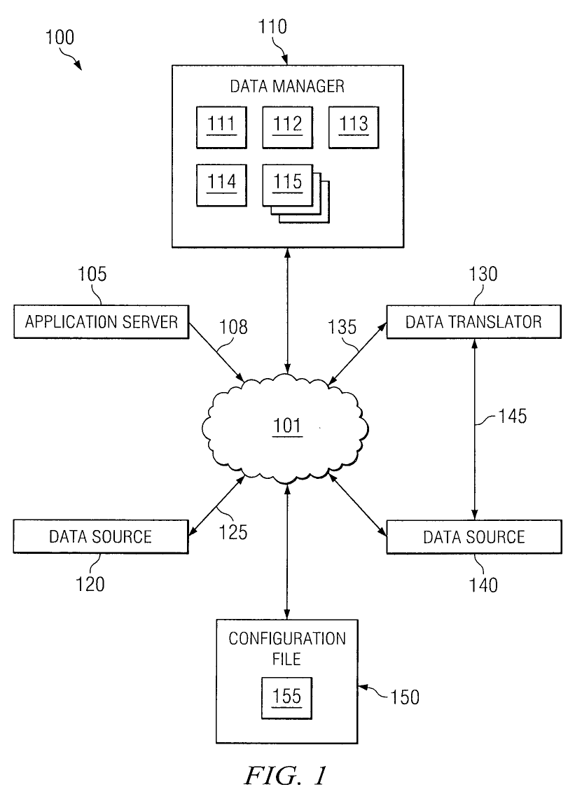

FIG. 1 illustrates a data processing system 100 for dynamically processing data between multiple data sources according to various embodiments of the invention. In particular embodiments, the data processing system 100 may be capable of processing an endless number of different data formats without extensive modifications. To facilitate such data processing, the data processing system 100 may use a configuration file 150 to provide real-time instructions on how to identify data, process data, convert data, and/or transfer data. In the embodiment shown in FIG. 1, the data processing system 100 includes a network 101, an application server 105, a data manager 110, a first data source 120, a data translator 130, and a second data source 140. Although particular components have been shown in FIG. 1, it should be understood that other embodiments of data processing system 100 with more, fewer, or different components may be used without departing from the scope of this disclosure.

The boxes illustrating the components of FIG. 1 represent functions, which may be carried out using any suitable hardware, software, or combination thereof. In particular embodiments, some or all of the boxes of FIG. 1 may be located at a single geographical location. In other embodiments, all of the boxes of FIG. 1 may be located on different machines at different geographical locations. In yet other embodiments, some of the boxes of FIG. 1 may be located on the same machine while other of the boxes may be located on different machines at different geographical locations.

The network 101 facilitates communication among the various components of system 100. The network 101 may, for example, communicate Internet Protocol (IP) packets, frame relay frames, Asynchronous Transfer Mode (ATM) cells, and/or other suitable information between network addresses or nodes. In particular embodiments, the network 101 may include, but is not limited to, all or a portion of the Internet, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding.

In some embodiments, the components of system 100 may reside on multiple enterprise domains. Accordingly, in such embodiments, the network 106 would be operable to communicate over these multiple enterprise domains. In other embodiments, components of system 100 may reside in the same department server, in which case network 101 may represent internal communication capabilities inherent in the department or server.

The configuration file 150 may represent any logic encoded in a computer readable media operable to store configuration file instructions 155. Configuration file instructions 155 may include information used by the data processing system 100, including, but not limited to, a variety of data processing specifications as well as relevant identification information and/or processing information. For example, in some embodiments, the configuration file instructions 155 may include an address sufficient to locate data, credentials to access the data, and specifications regarding how to process the data. Specifications regarding how to process data may include instructions on converting data into a new format, including specifying the new data format, and transmitting the converted data to a designated destination. Configuration file instructions 155 may also include other preferences or settings, such as instructions regarding when, where, and how often to process data. In particular embodiments, the configuration file 150 and its associated configuration file instructions 155 may be updateable by an administrator. In such embodiments, the administrator may be able to remotely access the configuration file 150 and/or configuration file instructions 155.

The application server 105 communicates with the data manager 110 using the network 101. The application server 105 may represent any hardware, software, firmware, or combination thereof operable to initiate a data processing request 108. The data processing request 108 may represent any signal capable of ordering data manager 110 to begin processing data according to specifications provided by one or both of the configuration file instructions 155 and data processing request 108. In particular embodiments, the application server 105 may be located on the same server or enterprise as the data manager 110, the configuration file 150, or any other component of data processing system 100. In other embodiments, the application server 105 may be located on an independent server or enterprise.

The data manager 110 consults the configuration file 150 over the network 101 and may interact with the first data source 120, the data translator 130, and the second data source 140. Further details of these interactions will be described below. In particular embodiments, the data manager 110 may be located on the same physical device as the application server, for example, being a software module executed thereon. As one example, in particular embodiments, both the application server 105 and the data manager 110 may be associated with an off-the-shelf J2EE platform such as Jboss, WebLogic, or an Oracle Application server. In particular embodiments, the data manager 110 may comprise any computing device operable to receive, transmit, process, and store data associated with the data processing system 100. For example, in particular embodiments, the data manager 110 may operate on a general-purpose personal computer (PC), a Macintosh, a workstation, a Unix-based computer, a server computer, or any other suitable device. Data manager 110 may includes memory 111, processor 112, and interface 113. Data manager may also include execution software 114 that may be stored in memory 111 and executed by processor 112. Although FIG. 1 provides one example of a server that may be used with embodiments of the invention, the data processing system 100 can be implemented using computers other than servers, as well as a server pool. The data manager 110 may include any hardware, software, firmware, or combination thereof operable to process data according to configuration file instructions 155.

The configuration file instructions 155 may identify the first data source 120 that provides data 125. The first data source 120 may be any suitable computing or communicating device operable to store and communicate data 125. The first data source 120 may, for example, represent a desktop computer, a laptop computer, a server, a mainframe, a scanner, a wireless device, and/or any other suitable device. The first data source 120 may also represent relational database management systems (RDBMS) such as Oracle, MySQL, PostgreSQL, and the like. The first data source 120 is not necessarily limited to a single computing or communicating device; rather, the first data source 120 may be one or more sources for data 125. The data 125 illustrates any structured or unstructured information in any format such as, for example, plain text, comma-separated-values (CSV) file, XML file, relational database table, EFT transaction, or any other suitable data structure. The data 125 obtained from the data source(s) 120 may be sets of information originating from multiple first data sources 120.

In particular embodiments, the data manager 110 may include a library of data source objects 115 that enables the data manager 110 to retrieve data through a variety of communication techniques. Examples communication techniques include, but are not limited to, Java Database (DB)/Java Database Connectivity (JDBC), Simple Object Access Protcol (SOAP), Unix-based file access, file transfer protocol (FTP), Java Message Service (JMS), socket, RSS, web services, remote procedure call (RPC), Common Object Request Broker Architecture (CORBA), real-time transport protocol (RTP), Transport Control Protocol (TCP) communications, and the like. Library 115 may include a catalog of data source objects enabling communication using communication techniques such as those listed above. If data source 120 requires a different communication technique, then an administrator can update the data manager 110 by adding the appropriate data source object to the library 115.

In particular embodiments, the data manager 110 may be capable of processing data through any communication technique by dynamically selecting the proper data source object from the library 115. For example, in one embodiment, the data 125 may represent information from a database stored at the first data source 120. In this embodiment, the data manager 110 may load a data source object from the library 115 operable to generate appropriate queries, read and process database data, using for example, JDBC. In another embodiment, the first data source 120 may be a web service, in which case the data manager 110 may use a data source object from library 115 operable to generate appropriate queries for the web service and read and process web service data. In yet more embodiments, the data manager 110 may require another object from library 115 to allow other types of communications with the first data source. Thus, data manager 110 can receive and process any data format as long as library 115 includes the correct data source object.

Embodiments of the data processing system system 100 feature dynamic discovery and processing of data 125. Once the data processing system 100 identifies the first data source 120, the data manager 110 may execute routines to identify data to be processed. For example, if first data source 120 contains database tables, the data manager 110 can discover data using JDBC commands. These JDBC commands are capable of performing tasks such as describing the table and identifying unprocessed table entries. The data manager 100 can also perform these routines dynamically in real time, allowing the data processing system 100 to adjust to any changes to first data source(s) 120. For example, if the data source 120 redefines its table headings or data format, the data manager 110 can dynamically incorporate such changes into its data processing.

Once the data processing system 100 discovers the new data 125, the data manager 100 can process data 125 in conformance with configuration file instructions 155. These configuration file instructions 155 in particular embodiments can be very customized and can specify a variety of processing routines. In one example embodiment, the data manager 110 may convert data 125 into an intermediate file format. For example, the data manager 110 may convert data 125 into a key-value associative array or other abstract data type. Associative arrays can be implemented in any programming language and many language systems provide them as part of their standard library. Other embodiments may utilize other data processing techniques, including forwarding data to another specialized data processing component.

In addition, in particular embodiments, changes to the configuration file instructions 155 will not necessarily require changes to the data manager 110. For example, a user may redefine the parameters of configuration file instructions 155 to instruct the data manager 110 to convert data 125 into an alternative file format. The data manager 110 in particular embodiments is operable to execute those new instructions dynamically without otherwise reprogramming the data manager 110. In some embodiments, the data manager 110 may resemble a specialized component that performs set tasks, such as autonomous, dynamic data processing in response to inputs from the configuration file 150 and the data source 120.

After the data manager 110 processes data according to configuration file instructions 155 and/or the information contained in the data processing request 108, the configuration file instructions 155 may further instruct the data manager 110 to forward the obtained/processed data, referred to in FIG. 1 as data 135, to the data translator 130. The data translator 130 may represent any suitable computing or communicating device operable to receive and process the data 135. In particular embodiments, the data translator 130 may, for example, represent a desktop computer, a laptop computer, a server, a mainframe, a scanner, a wireless device, and/or any other suitable device. The data translator 130 and the data manager 110 may be located on the same server or may be located on different servers or in different enterprises.

The data translator 130 communicates with the configuration file 150 via network 101 and is operable to retrieve or receive configuration file instructions 155. In some embodiments, the configuration file instructions 155 instruct the data translator 130 to convert the data 135 into a data format compliant with the data source 140. For example, the configuration file instructions 155 may order the data translator 130 to receive the data 135, convert the data 135 into Extensible Markup Language (XML) or another data format, and then forward the converted data 145 to the second data source 140. In other embodiments, the translation of the data 135 may not be necessary, and the data 135 can be communicated directly with data source 140. In some embodiments, the data translator 130 and the data manager 110 may be combined into a single operating unit.

The second data source 140 may be any suitable computing or communicating device operable to store and communicate data 145. The second data source 140 may, for example, represent a desktop computer, a laptop computer, a server, a mainframe, a scanner, a wireless device, and/or any other suitable device. The second data source 140 may also represent relational database management systems (RDBMS) such as Oracle, MySQL, PostgreSQL, and the like. The second data source 140 is not limited to a single computing or communicating device; rather, the second data source 140 could represent one or more receivers for data 145. In some embodiments, the data source 140 may be located on the same server as the data translator 130, the data source 120, the data manager 110, or application server 105. In other embodiments, data source 140 is located on an entirely different server or enterprise.

In some embodiments, the data source 140 may act merely as a storage repository for conditioned data sets. In other embodiments, the configuration file instructions 155 may include commands to update an existing data structure stored at the data source 140. For example, if the data 145 is a collection of processed database entries, the configuration file instructions 155 may instruct the data manager 110 or the data translator 130 to deliver the data 145 to an existing database at the data source 140. In another embodiment, the data source 140 may be operable to update the configuration file 150. For example, the data source 140 may inform the configuration file 150 that the data 145 has been successfully delivered.

As suggested above, the configuration file instructions 155 can order either a one-time data process or a continuous data process. In embodiments where the data processing system system 100 is continuously processing data, the data processing system system 100 can continuously refer to configuration file instructions 155 for guidance. In such an embodiment, a user may execute run-time changes to how the data processing system system 100 processes data without stopping the data processing system system 100 operations. As an example, if data processing system system 100 is continuously processing data between the first data source 120 and the data source 140, but the user wants to designate a second destination data source, the user may modify the destination data source in the configuration file instructions 155 without disrupting the data processing between the first data source 120 and the second data source 140. In another example, a user could modify the range of data pulled from the data source 120 without halting current data processing. These are just two examples of the unlimited real-time changes available through the use of the configuration file 150.

In addition, the configuration file 150 provides unlimited flexibility to the data processing system system 100. Rather than hardcode the application server 105, the data manager 110, and other components of the data processing system system 100, these components can be coded to operate based on inputs from the configuration file 150. For example, the configuration file 150 may be capable of informing the application server 105 how to execute code (as a web service, as an application, etc.). Whereas one might consider the system 100 as a collection of components performing automated data processing tasks, the configuration file 150 provides a means for easily customizing the operation of system 100. Thus, embodiments of the current invention may provide responsive and autonomous data processing by adapting to the configuration file instructions 155 and dynamically processing data between sources based on those instructions.

Modifications, additions, or omissions may be made to the data processing system 100 of FIG. 1 without departing from the scope of the invention. The components of the data processing system 100 may be integrated or separated over different networks or enterprises according to particular needs. Moreover, the operations of data processing system 100 may be performed by more, fewer, or other modules and/or components. Additionally, operations of the data processing system 100 may be performed using any suitable logic comprising software, hardware, other logic devices, or any suitable combination of the preceding.

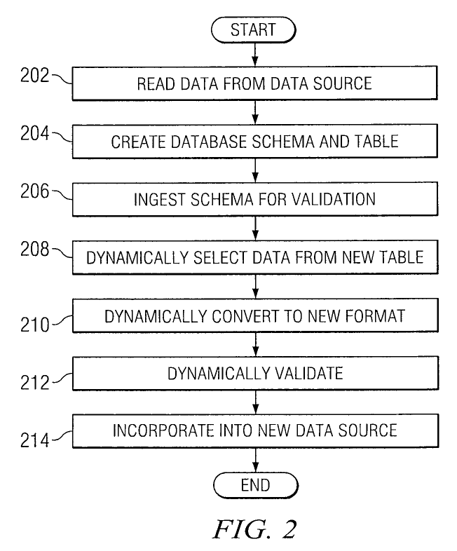

FIG. 2 is a flowchart illustrating a series of example steps associated with dynamically discovering and translating data as a single autonomous operation performed by logic encoded in a computer readable media. These steps may be incorporated in whole or in part into the data processing system 100. The first step, according to the embodiment of FIG. 2 is identifying and acquiring data from the data source at step 202. Step 202 may include consulting configuration file 155, which may identify the data to be acquired. Once the data is identified, the logic can dynamically perform steps 204 through 212 without user interface.

In one embodiment, the method outlined in FIG. 2 might be used to read and convert a database table into XML. In step 204, the logic may dynamically create an XML Schema Definition (XSD) for each database table by ingesting the database table headings. In step 206, the logic may validate the XSD with Java API for XML Processing (JAXP). Next, in steps 208 and 210, the logic may select data from the table to be converted (as may be defined in the configuration file instructions 155) and then dynamically convert the data into XML. Thus, once steps 204 and 206 establish the structure of the data, the logic can actually retrieve and convert the data in steps 208 and 210. In step 212, the logic could dynamically validate the new XML data using run-time JAXP. Finally, in step 214, the logic may integrate the new XML data into an existing data store.

The flowchart in FIG. 2 and accompanying description illustrates an exemplary method of operation for dynamically discovering and translating data as a single autonomous operation performed by logic encoded in a computer readable media. Because the flowchart and description is only illustrative, the data processing system 100 contemplates using methods with additional steps, fewer steps, and/or, so long as the method remains appropriate. For example, the validation steps may be modified or eliminated where the target data does not require validation. In addition, as discussed above, different embodiments of the current invention are capable of processing unlimited types of data. Whereas the above example referred to database data, variations of the steps outlined above can apply to other data types as well.

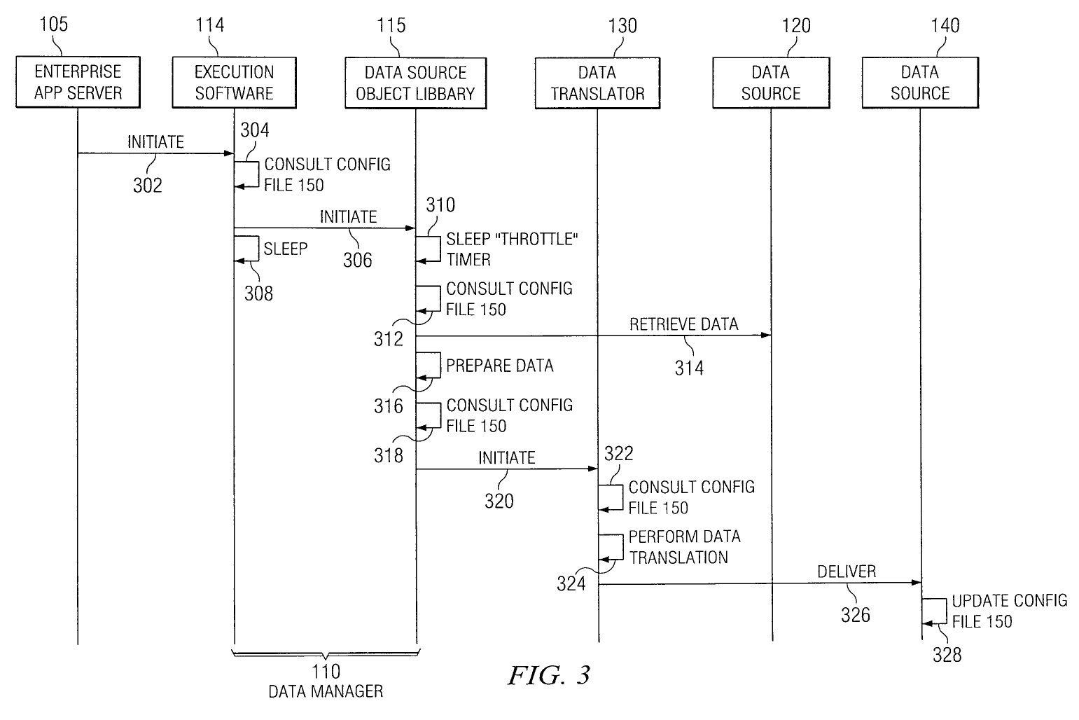

FIG. 3 illustrates how the data processing system 100 of FIG. 1 may identify, process, and convert data, according to an embodiment of the disclosure. Although FIG. 3 and its accompanying description describes particular steps in the processing of data, additional and/or fewer steps may be used with the data processing system 100, according to other embodiments of the disclosure.

At step 302, the application server 105 may submit a request for data processing to the data source manager 110. In particular embodiments, this request for data processing can be dynamically created by the configuration file 150. As an example, the configuration file instructions 155 may require continuous data processing, and accordingly the configuration file instructions 155 can autonomously instruct data source manager 110 to commence data processing. As another example, in particular embodiments, the configuration file instructions 155 may be associated with a chron job, which is executable at a predetermined time and updateable by an administrator.

After receiving the request for data processing, the data source manager 110 may consult the configuration file 150 at step 304 for configuration file instructions 155, which among other things may identify the data to be retrieved from data source 120. In particular embodiments, the data source manager 110 may then initiate a data source object from the library 115 to process the data according to steps 310 to 318. After initiating this processes, the data source manager 110 can wait for the next data processing request.

The data source object awakens at step 310 and begins to handle the data processing request, which in this particular embodiment is a request for data from the first data source 120. At step 312, the data source object consults configuration file instructions 155 for information such as an address to obtain the data, credentials necessary to access the data, and other specifications associated with obtaining the data (e.g., query format and the like). At step 314, the data source object retrieves the data from data source 120.

At step 316, the data manager 110 may further process the retrieved data as required by the configuration file instructions 155. For example, the data manager 110 may make a key-value representation of data and then start mapping received table headings to the stored value. In other embodiments, the data processing system 100 may utilize other appropriate methods for processing the data. For example, if the first data source 120 is a web service, a file server, or an RSS feed, then the data processing system 100 may require a different method for processing the data and would use a different data source object from library 115.

At step 318, the data manager 110 may again consult the configuration file instructions 155 for further information on what to do with the data. Configuration file instructions 155 may identify the next recipient of the processed data and instruct the data manager 110 to transmit the data to another component. For example, at step 320, the data manager 110 may communicate the processed data to the data translator 130 as may required by the configuration file instructions 155.

At step 322, the data translator 130 may consult the configuration file instructions 155 for data translation instructions. For example, the configuration file instructions 155 may identify the second data source 140 and require data translator 130 to convert the data into a format compatible with second data source 140. At steps 324 and 326, data translator 130 will perform the data translation and deliver the data to data source 140.

In embodiments where the data processing system 100 executes continuous data processing, the second data source 140 may complete a data processing iteration by updating the configuration file 150. For example, the second data source 140 may inform the configuration file 150 that one iteration of data processing is complete. Accordingly, the data processing system 100 may use this information in determining when the next data processing iteration should begin and/or what information should be obtained. For example, in particular embodiments, only delta data may be obtained. Although this step has been described, it should be understood that such a step merely as an example of how the configuration file 150 can interact within the data processing system 100 and is not required to appreciate many of the features of the data processing system 100. Rather, the communications between the configuration file 150 and the data processing system 100 can be modified and adapted without significantly altering the operation of the data processing system 100.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶ of 35 U.S.C. § 112 as it exists on the date of filing hereof unless the words “means for” or “step for” are explicitly used in the particular claim.

What is claimed is:

1. A method for dynamically processing electronic data between multiple data sources, the method comprising:
obtaining a first data set from a data source,
consulting a run-time updateable configuration file to determine a first destination for the first data set;
transmitting the first data set to the first destination;
consulting, at the first destination, the run-time updateable configuration file to determine instructions for processing of the first data set, the instructions for processing the first data set comprising conversion information and the first destination being a data translator;
converting, at the data translator, the first data set according to the conversion information, the conversion yielding a processed first data set;
consulting the run-time updateable configuration file to determine a second destination for the processed first data set;
transmitting the processed first data set to the second destination; and
updating, from a remote administrator computer, the run-time updateable configuration file.

2. The method of claim 1, further comprising:
updating the run-time updateable configuration file with information from the transmitting of the processed first data set to the second destination.

3. The method of claim 1, further comprising:
receiving a request, the request based in part upon information contained in the run-time updateable configuration file, the obtaining of the first data set from the data source being carried out in response to the request.

4. The method of claim 1, wherein the run-time updateable configuration file further comprise specifications associated with obtaining data from the data source, the method further comprising:
transmitting a query to the data source based upon the specifications.

5. A method for dynamically processing electronic data between multiple data sources, the method comprising:
obtaining a first data set from a data source,
consulting a run-time updateable configuration file to determine a first destination for the first data set;
transmitting the first data set to the first destination;
consulting, at the first destination, the run-time updateable configuration file to determine instructions for processing of the first data set;
processing the first data set according to the instructions to yield a processed first data set; and
consulting the run-time updateable configuration file to determine a second destination for the processed first data set; and
transmitting the processed first data set to the second destination.

6. The method of claim 5, wherein the second destination is a second data source.

7. The method of claim 5, further comprising:
updating, from a remote administrator computer, the run-time updateable configuration file

8. The method of claim 5, wherein the run-time updateable configuration further comprise an identification of the data source, the method further comprising:
consulting the updateable configuration to determine where to obtain the first data set.

9. The method of claim 5, wherein the run-time updateable configuration file further comprise specifications associated with obtaining data from the data source, the method further comprising:
transmitting a query to the data source based upon the specifications.

10. The method of claim 5, further comprising:
updating the run-time updateable configuration file with information from the transmitting of the processed first data set to the second destination.

11. The method of claim 5, further comprising:
preparing, at a data manager, the first data set prior to transmitting the first data set to the first destination, the preparing of the first data set carried out in accordance with preparation information contained in the run-time updateable configuration file.

12. The method of claim 5, further comprising:
receiving a request, the request based in part upon information contained in the run-time updateable configuration file, the obtaining of the first data set from the data source being carried out in response to the request.

13. A system for dynamically processing electronic data between multiple data sources, the system comprising:
logic encoded in a computer readable media such that when executed is operable to:
obtain a first data set from a data source,
consult a run-time updateable configuration file to determine a first destination for the first data set,
transmit the first data set to the first destination,
consult, at the first destination, the run-time updateable configuration file to determine instructions for processing of the first data set,
process the first data set according to the instructions to yield a processed first data set,
consult the run-time updateable configuration file to determine a second destination for the processed first data set, and
transmit the processed first data set to the second destination.

14. The system of claim 13, wherein at least some of the logic is dispersed at a different geographic location than the remainder of the logic.

15. The system of claim 13, wherein
the instructions for processing the first data set comprises conversion information and the first destination is a data translator, and
the logic is processing the first data set according to the instructions converts, at the data translator, the data according to the conversion information.

16. The system of claim 13, wherein
the run-time updateable configuration file further comprise an identification of the data source, and
the logic is further operable to consult the run-time updateable configuration file to determine where to obtain the first data set.

17. The system of claim 13, wherein
the run-time updateable configuration file further comprise specifications associated with obtaining data from the data source, and
the logic is further operable to transmit a query to the data source based upon the specifications.

18. The system of claim 13, wherein the logic is further operable to:
update the run-time updateable configuration file with information from the transmitting of the processed first data set to the second destination.

19. The system of claim 13, wherein the logic is further operable to:
prepare, at a data manager, the first data set prior to transmitting the first data set to the first destination, the preparing of the first data set carried out in accordance with preparation information contained in the run-time updateable configuration file.

20. The system of claim 13, wherein the logic is further operable to:
receive a request, the request based in part upon information contained in the run-time updateable configuration file, the obtaining of the first data set from the data source being carried out in response to the request.
